(19) United States
(12) Patent Application Publication
(10) Pub. No.: US 2026/0023560 A1
(43) Pub. Date: Jan. 22, 2026

(54) RAPID DEPLOYABLE ORCHESTRATED ENVIRONMENT FOR MODEL-BASED SYSTEMS ENGINEERING

(71) Applicant: V.E.T.S, LLC, Madison, AL (US)

(72) Inventors: Jason Thompson, Huntsville, AL (US); Eric Deitrick, New Smyrna Beach, FL (US); Matthew Davis, Brownsboro, AL (US)

(21) Appl. No.: 19/267,270

(22) Filed: Jul. 11, 2025

Related U.S. Application Data
(60) Provisional application No. 63/672,502, filed on Jul. 17, 2024.
(60) Provisional application No. 63/722,868, filed on Nov. 20, 2024.

(51) Int. Cl. G06F 8/77; G06F 8/35

(52) U.S. Cl. CPC G06F 8/77; G06F 8/35

(57) ABSTRACT

A system for deploying a model-based systems engineering (MBSE) environment includes a management cluster configured to deploy a workload cluster. A rapid deployable orchestrated environment (RDOE) is implemented within the workload cluster. The RDOE includes a server-based application configured to store MBSE model data and a client development application configured to manipulate the MBSE model data. The RDOE is partitionable into separate areas for multiple client companies to utilize.

### CROSS-REFERENCE TO RELATED APPLICATIONS

This application claims priority to and the benefit of U.S. Provisional Application No. 63/672,502, titled “Partitioning Cloud-Based Model-Based Systems Engineering Servers,” filed Jul. 17, 2024, and U.S. Provisional Application No. 63/722,868, titled “Rapid Deployable Orchestrated Environment (RDOE) for Model-Based Systems Engineering,” filed Nov. 20, 2024, both of which are hereby incorporated by reference.

### FIELD OF TECHNOLOGY

The present disclosure relates to model-based systems engineering (MBSE) environments, and more particularly to a rapid deployable orchestrated environment (RDOE) for implementing and managing MBSE tools and data across multiple client companies.

### BACKGROUND

Model-based systems engineering (MBSE) has become increasingly prevalent in various industries for designing and managing complex systems. As projects grow in scale and complexity, organizations face challenges in efficiently deploying, managing, and collaborating on MBSE environments. Traditional approaches often involve time-consuming setup processes, limited scalability, and difficulties in maintaining consistent environments across teams and projects.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for deploying a model-based systems engineering (MBSE) environment is provided. The system includes a management cluster configured to deploy a workload cluster. The system includes a rapid deployable orchestrated environment (RDOE) implemented within the workload cluster. The RDOE comprises a server-based application configured to store MBSE model data and a client development application configured to manipulate the MBSE model data. The RDOE is partitionable into separate areas for multiple client companies to utilize.

In an exemplary embodiment, the server-based application comprises a model repository configured to store MBSE model data. The model repository includes template components, reuse library components, and reference architecture components.

In an exemplary embodiment, the server-based application comprises a license manager configured to manage licenses for the client development application. The license manager includes guide components, client license components, and server license components. The server-based application comprises a source code repository configured to store deployment configuration files. The source code repository includes template components and guide components.

According to another aspect of the present disclosure, a method for deploying a model-based systems engineering (MBSE) environment is provided. The method includes deploying a workload cluster using a management cluster. The method includes implementing a rapid deployable orchestrated environment (RDOE) within the workload cluster. The method includes configuring a server-based application within the RDOE to store MBSE model data. The method includes configuring a client development application within the RDOE to manipulate the MBSE model data. The method includes partitioning the RDOE into separate areas for multiple client companies to utilize.

In an exemplary embodiment, configuring the server-based application comprises implementing a model repository to store MBSE model data, the model repository including template components, reuse library components, and reference architecture components. Configuring the server-based application also comprises implementing a license manager to manage licenses for the client development application, the license manager including guide components, client license components, and server license components.

In an exemplary embodiment, configuring the server-based application comprises implementing a source code repository to store deployment configuration files, the source code repository including template components and guide components.

In an exemplary embodiment, the method further includes implementing multiple versions of the client development application and the server-based application within the RDOE, and enabling migration of data between different versions of the client development application and the server-based application.

In an exemplary embodiment, the method further includes implementing automated data backup and disaster recovery processes for the RDOE.

In an exemplary embodiment, the method further includes implementing infrastructure-as-code (IaC) to orchestrate the RDOE, and utilizing the IaC to enable drift correction and configuration management to maintain security of the RDOE.

According to another aspect of the present disclosure, a non-transitory computer-readable medium storing instructions that, when executed by a processor, cause the processor to perform operations for deploying a model-based systems engineering (MBSE) environment is provided. The operations include deploying a workload cluster using a management cluster. The operations include implementing a rapid deployable orchestrated environment (RDOE) within the workload cluster. The operations include configuring a server-based application within the RDOE to store MBSE model data. The operations include configuring a client development application within the RDOE to manipulate the MBSE model data. The operations include partitioning the RDOE into separate areas for multiple client companies to utilize.

In an exemplary embodiment, configuring the server-based application comprises implementing a model repository to store MBSE model data, the model repository including template components, reuse library components, and reference architecture components.

In an exemplary embodiment, configuring the server-based application comprises implementing a license manager to manage licenses for the client development application, the license manager including guide components, client license components, and server license components.

In an exemplary embodiment, configuring the server-based application comprises implementing a source code repository to store deployment configuration files, the source code repository including template components and guide components.

In an exemplary embodiment, the operations further include implementing multiple versions of the client development application and the server-based application within the RDOE, and enabling migration of data between different versions of the client development application and the server-based application.

In an exemplary embodiment, the operations further include implementing automated data backup and disaster recovery processes for the RDOE, implementing infrastructure-as-code (IaC) to orchestrate the RDOE, and utilizing the IaC to enable drift correction and configuration management to maintain security of the RDOE.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a rapid deployable orchestrated environment (RDOE) system, according to aspects of the present disclosure.

FIG. 2 illustrates a flowchart for a customer request workflow process, according to an embodiment.

FIG. 3 illustrates a flowchart for deploying a model-based systems engineering (MBSE) environment method, in accordance with example embodiments.

FIG. 4 illustrates a block diagram of a computing system, according to aspects of the present disclosure.

FIG. 5 illustrates a flowchart of an RDOE deployment process, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The adoption of cloud computing and containerization technologies has opened new possibilities for deploying software environments. However, integrating these technologies with MBSE tools and workflows presents its own set of challenges. Organizations struggle to balance the need for flexibility, security, and ease of use while ensuring that their MBSE environments can adapt to changing project requirements. Furthermore, as companies increasingly collaborate with external partners and vendors, there is a growing demand for MBSE environments that can be easily partitioned and shared across organizational boundaries. This requires careful consideration of data security, access control, and version management to maintain the integrity of sensitive engineering data. The field of MBSE continues to evolve, with new tools and methodologies emerging regularly. This rapid pace of change makes it difficult for organizations to keep their MBSE environments up-to-date and ensure compatibility between different components of their engineering toolchain. There is a clear need for solutions that can streamline the deployment and management of MBSE environments while providing the agility to incorporate new technologies and practices as they emerge.

In brief overview, embodiments of the Rapid Deployable Orchestrated Environment (RDOE) represent a comprehensive solution for Model-Based Systems Engineering (MBSE) that addresses the complex needs of modern engineering projects. The RDOE provides a flexible and secure platform for companies to collaborate on MBSE projects without the burden of managing complex infrastructure. The RDOE may be implemented within a workload cluster, offering a scalable and efficient environment for MBSE activities. The RDOE is partitioned into separate areas, allowing multiple client companies to utilize the same infrastructure while maintaining data isolation and security. In some cases, the RDOE may be configured to handle sensitive information, including Controlled Unclassified Information (CUI) and data subject to U.S. International Traffic in Arms Regulations (ITAR). This capability enables defense contractors and other organizations working with sensitive data to leverage the benefits of cloud-based MBSE tools while adhering to strict security requirements.

Embodiments of the RDOE may include multiple versions of client development applications and server-based applications. This multi-version support allows companies to work with the tools that best suit their needs and project requirements. Furthermore, the system may enable the migration of data between different versions of these applications, providing flexibility and reducing the risk of version incompatibility issues. To enhance collaboration and standardization across projects, each MBSE tool server instance within the RDOE may include a shared library (e.g. “VETS Model Library Cameo Project”). The shared library may contain reusable model elements, style guides, and best practices that companies can leverage to improve consistency and efficiency in their modeling efforts. Further, each server may be mirrored to enable redundancy and parallel loading of model data, which helps ensure high availability and improved user experience, particularly when working with large or complex models. The RDOE may also incorporate automated data backup and disaster recovery processes. These features help protect valuable engineering data and minimize downtime in the event of system failures or other disruptions. By automating these critical processes, the RDOE reduces the administrative burden on client companies and helps ensure the continuity of engineering projects.

Embodiments of the RDOE offers a comprehensive and flexible solution for Model-Based Systems Engineering. By addressing key challenges such as security, collaboration, version management, and data protection, the RDOE enables companies to focus on their core engineering tasks while benefiting from a robust and efficient MBSE infrastructure.

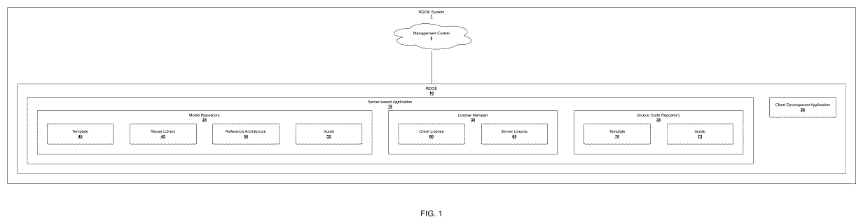

The Rapid Deployable Orchestrated Environment (RDOE) system 1, as illustrated in FIG. 1, may comprise several interconnected components arranged in a hierarchical structure. At the top level, the system includes a management cluster 5, which may be responsible for overseeing and controlling the entire MBSE environment. The RDOE is being instantiated within the workload cluster. This step is just signifying that it is be instantiated at that moment.

Connected to the management cluster 5 is the RDOE 10, which may serve as the core framework for MBSE activities. The RDOE 10 branches into two main components: a server-based application 15 and a client development application 20. These components work in tandem to provide a comprehensive MBSE solution. The server-based application 15 is further divided into three key repositories: a model repository 25, a license manager 30, and a source code repository 35. Each of these repositories may play a specific role in managing different aspects of the MBSE environment.

The model repository 25 contains several subcomponents, including a template 40, a reuse library 45, and a reference architecture 50. These subcomponents may provide standardized structures, reusable elements, and architectural guidelines for MBSE projects. Additionally, a guide 55 may be associated with the model repository 25, potentially offering instructions or best practices for utilizing the repository's components. The license manager 30 includes at least three subcomponents: a client license 60, a server license 65, and another instance of the guide 55. The guide components may provide instructions or best practices for license management, while the client and server license components may handle the allocation and tracking of licenses for various MBSE tools and applications used within the environment. The source code repository 35 may contain two subcomponents: a template 70 and another instance of the guide 75. These elements may provide standardized structures for configuration files and instructions on how to effectively use and customize these templates. The client development application 20, while not shown with specific subcomponents in FIG. 1, may represent the user-facing tools and interfaces that engineers and designers use to interact with the MBSE models and data stored in the server-based application 15.

This hierarchical structure allows for efficient management and scalability of the MBSE environment. The separation of server-based and client-facing components enables flexible deployment and customization to meet specific project needs, while the various repositories and their subcomponents may provide a robust framework for managing models, licenses, and deployment configurations.

Referring still to FIG. 1, the RDOE system 1 represents a comprehensive system for MBSE that integrates various components to create a flexible and efficient infrastructure. The RDOE system 1 may comprise a management cluster 5 configured to deploy and manage one or more workload clusters. The management cluster 5 may serve as the control and entry point for the deployed workloads and environments. The workload cluster, deployed by the management cluster 5, may contain the RDOE 10. Within the RDOE 10, two primary components may coexist: server-based applications 15 and client development applications 20. Server-based applications 15 within the RDOE 10 are configured to store MBSE model data. These server-based applications 15 may include, but are not limited to, model repositories 25, license managers 30, and source code repositories 35. In some cases, the server-based applications may be containerized or non-containerized, depending on the specific requirements and capabilities of each application. Client development applications 20, on the other hand, are configured to manipulate the MBSE model data stored in the server-based applications 15. These client development applications 20 may provide an interface through which engineers and designers interact with the MBSE models, allowing for collaborative work on complex systems.

Embodiments of the RDOE 10 are designed to be partitionable into separate areas, enabling multiple client companies to utilize the same infrastructure while maintaining data isolation and security. The partitioning mechanism is either logical or physical. Dedicated instances of AWS may count as physical partitions, or any other partitioning may count as logical. This partitioning may be achieved through various means, such as namespace isolation in Kubernetes or other containerization technologies. Configuration files may be generated and placed in a designated directory within a workload repository. These configuration files may be written in formats such as YAML or JSON, providing a standardized way to define the environment's settings and parameters. To maximize reuse and minimize the workload for end users, the RDOE 10 may employ open source tools like Kustomize to assemble configuration files. Kustomize may allow for the creation of base configurations that can be easily customized for specific use cases or client requirements through overlays.

The RDOE system 1 provides the necessary security for MBSE. For instance, value or property files containing sensitive information may be encrypted prior to being committed to the repository. This encryption process may help ensure the security of sensitive data and prevent unauthorized access. The RDOE 10 may implement a robust authentication system for client access. In some cases, client systems may authenticate with the TWC (Teamwork Cloud) service based on Role-Based Access Control (RBAC) and Attribute-Based Access Control (ABAC). This multi-faceted approach to access control may provide fine-grained security measures, ensuring that users only have access to the resources and data they are authorized to use.

To orchestrate the RDOE 10, Infrastructure-as-Code (IaC) principles may be employed. IaC may allow for the definition and management of the entire infrastructure through code, enabling version control, reproducibility, and automated deployment. In some cases, IaC may be utilized to enable drift correction and configuration management, helping to maintain the security and integrity of the RDOE over time. The RDOE 10 may incorporate an Environment Orchestrator, such as an open source tool like FluxCD, to manage the configuration and deployment process. This orchestrator may be responsible for transcribing and importing configuration files into the workload cluster. Working in conjunction with the Environment Orchestrator, a Services Orchestrator, such as an open source tool like Crossplane may monitor for new or updated configurations and consume custom providers to instantiate and manage services within the RDOE 10. Automation of backups and disaster recovery may be an integral part of the RDOE configuration. In some cases, the RDOE may include definitions that allow for automated backup processes and disaster recovery procedures. These automated processes may help ensure data integrity and minimize downtime in the event of system failures or other disruptions.

The RDOE system 1, including its components and functionalities, may be implemented and managed through instructions stored on a non-transitory computer-readable medium. When executed by a processor, these instructions may cause the processor to perform the operations necessary for deploying and managing the MBSE environment, including the deployment of workload clusters, implementation of the RDOE, configuration of server-based and client development applications, and partitioning of the environment for multiple client companies. By centralizing control and management functions within the Management Cluster, the RDOE may provide a more streamlined and efficient approach to deploying and maintaining MBSE environments. This centralized management may help organizations reduce the complexity and overhead associated with managing multiple MBSE environments, potentially allowing engineering teams to focus more on their core design and development tasks.

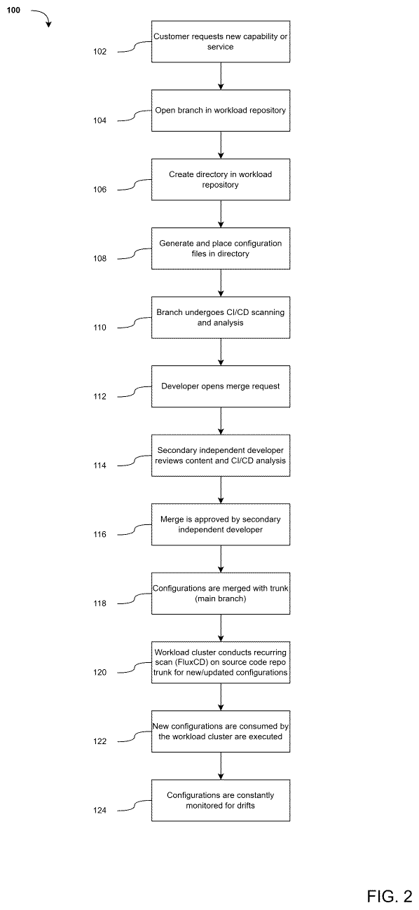

Turning now to FIG. 2, the RDOE deployment process may follow a structured workflow, as illustrated in FIG. 2. FIG. 2 depicts a customer request workflow process 100, which may comprise several steps for deploying and configuring the RDOE.

The process 100 may begin with step 101, where a customer requests a new capability or service. This initial request triggers a series of actions within the RDOE system. Following the customer request, step 102 opens a branch in the workload repository. This step may allow for isolated development and testing of the requested capability without affecting the main production environment. In step 103, a directory may be created in the workload repository. This directory may serve as a dedicated space for storing configuration files and other resources related to the requested capability. Step 104 may involve generating configuration files and placing them in the directory created in step 103. In some cases, these configuration files may be written in formats such as YAML or JSON, providing a standardized way to define the environment's settings and parameters. To maximize reuse and minimize the workload for end users, step 105 may involve using Kustomize to assemble the configuration files. Kustomize may allow for the creation of base configurations that can be easily customized for specific use cases or client requirements through overlays. In step 106, a developer opens a merge request to integrate the new configuration into the main branch of the workload repository.

In step 107, a secondary independent developer reviews the content and conduct CI/CD analysis. In step 108, a merge may be approved by an independent developer. These parallel review processes may help ensure the quality and security of the new configuration. In step 109, the approved configurations are merged with the trunk (main branch) of the workload repository. Step 110 involves a recurring scan of the source code repository trunk for new or updated configurations. This scan may be performed by the workload cluster to detect any changes that need to be applied to the RDOE. In step 111, new configurations are consumed by the workload cluster and executed by a Services Orchestrator, such as Crossplane. The Services Orchestrator may monitor for configurations and instantiate instances of services based on the new or updated configurations. The final step, step 112, involves constant monitoring of configurations for drift. This ongoing process may help ensure that the deployed environment remains consistent with the defined configurations over time. Throughout this process, security measures may be implemented to protect sensitive information.

The RDOE deployment process may also incorporate an Environment Orchestrator, such as FluxCD, to manage the configuration and deployment process. The Environment Orchestrator may be responsible for transcribing configuration files and importing configurations into the workload cluster. In some cases, client system authentication with the TWC (Teamwork Cloud) service may be based on Role-Based Access Control (RBAC) and Attribute-Based Access Control (ABAC). This multi-faceted approach to access control may provide fine-grained security measures, ensuring that users only have access to the resources and data they are authorized to use. By following this structured workflow, the RDOE deployment process may provide a systematic approach to implementing and managing Model-Based Systems Engineering environments. The process may incorporate multiple layers of review, security measures, and automated configuration management to ensure the reliability and efficiency of the deployed RDOE.

The RDOE 10 may implement automated data backup and disaster recovery processes to protect valuable engineering data and minimize downtime in the event of system failures or other disruptions. In some cases, these automated processes may include regular backups of model data, configuration files, and other critical information. The backup process may be designed to minimize impact on system performance while ensuring comprehensive data protection. To enhance reliability and performance, each server within the RDOE may be mirrored. This mirroring approach may enable redundancy and parallel loading of model data. By implementing server mirroring, the RDOE may help ensure high availability and improved user experience, particularly when working with large or complex models. In some cases, the mirrored servers may be geographically distributed to provide additional resilience against localized disruptions. The disaster recovery processes within the RDOE may be designed to quickly restore system functionality in the event of a failure. These processes may include automated failover mechanisms that switch to backup servers or alternate data centers if primary systems become unavailable. In some cases, the disaster recovery plan may include procedures for data replication and synchronization between primary and backup systems to minimize data loss in the event of a failure.

The Rapid Deployable Orchestrated Environment (RDOE) may support multiple versions of applications and enable data migration between different versions. This capability may provide flexibility and continuity for client companies using the MBSE environment. In some cases, the RDOE may implement multiple versions of the client development application within the environment. This approach may allow different teams or projects to use the version of the application that best suits their needs or requirements. For example, one team may use an older version of the application for compatibility with existing projects, while another team may utilize a newer version to take advantage of updated features. Similarly, the RDOE may support multiple versions of the server-based application. This multi-version support for server-based applications may enable organizations to maintain consistency with their existing workflows while gradually transitioning to newer versions as needed. The RDOE 10 may enable migration of data between different versions of the client development application. This capability may allow organizations to upgrade their MBSE tools without losing access to existing model data. In some cases, the data migration process may involve automated conversion tools that translate model data from one version format to another.

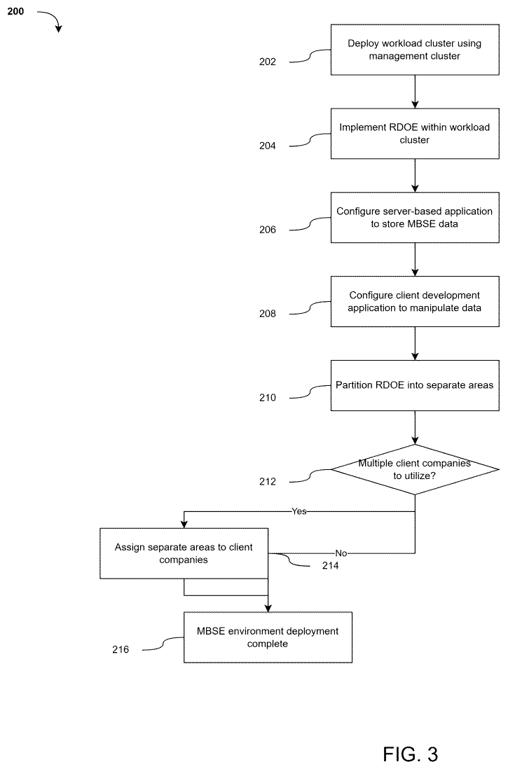

FIG. 3 illustrates a flowchart depicting a method 200 for deploying a model-based systems engineering (MBSE) environment. The method 200 begins with step 202, where a workload cluster is deployed using a management cluster. This initial step establishes the foundational infrastructure for the MBSE environment. Following the deployment of the workload cluster, the method 200 proceeds to step 204, where the RDOE is implemented within the workload cluster. This implementation may involve setting up the necessary components and configurations to support MBSE activities. In step 206, a server-based application is configured within the RDOE to store MBSE model data. This configuration may include setting up databases, file systems, or other storage mechanisms optimized for handling MBSE-related information.

The method 200 continues to step 208, where a client development application is configured within the RDOE to manipulate the MBSE model data. This step involves installing and setting up the necessary software tools and interfaces that engineers and designers will use to interact with the MBSE models. In step 210, the RDOE may be partitioned into separate areas. This partitioning may allow for the creation of isolated environments within the RDOE, which can be useful for managing different projects or teams. The method 200 then reaches a decision point at step 212, where it is determined whether multiple client companies will utilize the environment. The decision step 212 may be implemented as a conditional statement within the software code executing the method. Based on the outcome of this decision, the method may execute different code paths to handle single or multi-tenant scenarios. If the answer is “Yes,” the method may proceed to step 214, where separate areas are assigned to different client companies. This assignment may involve configuring access controls, data isolation mechanisms, and other security measures to ensure that each client company's data and resources remain separate and secure. If the answer at step 212 is “No,” or after completing step 214, the method 200 concludes at step 216, where the MBSE environment deployment is considered complete. At this point, the RDOE may be fully configured and ready for use by engineers and designers for MBSE activities.

The flowchart in FIG. 3 demonstrates a systematic approach to deploying an MBSE environment, taking into account the need for proper infrastructure setup, application configuration, and multi-tenant support. This method provides a structured process for organizations to establish a robust and flexible MBSE environment tailored to their specific requirements.

The method 200 for deploying a model-based systems engineering (MBSE) environment may be implemented using one or more computing devices. In some aspects, the method 200 may be executed by one or more processors of a computing device, such as a server, workstation, or cloud-based system. The computing device may include memory storing instructions that, when executed by the processor, cause the processor to perform the steps of the method 200. In some implementations, the management cluster and workload cluster may be implemented as virtual machines or containers running on one or more physical servers. The RDOE 10 may be implemented as a set of software components distributed across the workload cluster. The server-based application 15 and client development application 20 may be implemented as software programs running on the workload cluster. In some cases, these applications may be containerized for easier deployment and management.

The partitioning of the RDOE into separate areas may be achieved through logical separation within the software environment, such as through the use of namespaces, virtual private networks, or other isolation techniques.

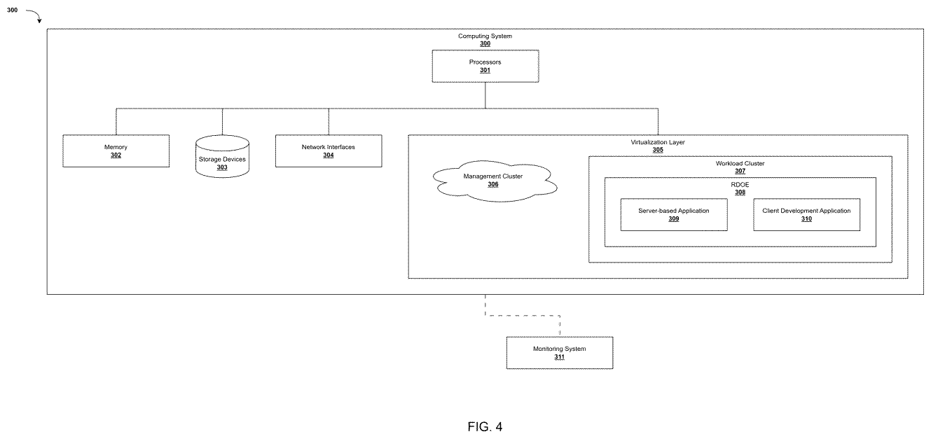

FIG. 4 illustrates a block diagram of a computing system 400 for implementing the RDOE system 1. The computing system 400 includes one or more processors 410 coupled to memory 420 that stores instructions for executing method 200. The computing system 400 also includes storage devices 430 for persistently storing MBSE model data and configuration information. Network interfaces 440 enable communication with client devices 450 accessing the MBSE environment. The computing system 400 implements a virtualization layer 460 that hosts the management cluster 5 and workload cluster 470. The workload cluster 470 contains the RDOE 10 with its server-based application 15 and client development application 20 components. A monitoring system 480 tracks deployment progress and system health.

In some implementations, the method 200 may be executed as part of a larger orchestration system that manages the deployment and configuration of MBSE environments. This system may use infrastructure-as-code techniques to define and manage the RDOE components.

The computing system 400 implements logging and monitoring capabilities through the monitoring system 480 to track the progress of the deployment process and detect any issues that may arise during the execution of the method 200. This may include generating log files, sending notifications, or updating status indicators in a management interface.

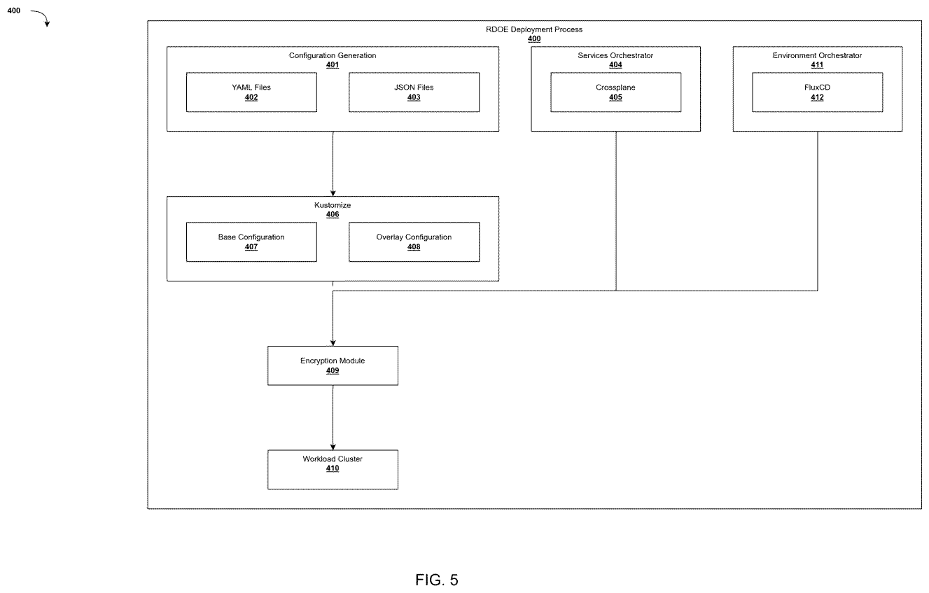

FIG. 5 illustrates a flowchart depicting an embodiment of a deployment process 400 for the Rapid Deployable Orchestrated Environment (RDOE). The process begins with configuration generation 401, which may involve creating both YAML files 402 and JSON files 403. These configuration files may contain the necessary specifications for deploying and managing the RDOE components.

The process then flows to a Kustomize 406 component, which includes base configuration 407 and overlay configuration 408. Kustomize 406 may be used to customize and manage the configuration files, allowing for flexible and reusable configurations across different environments or deployments.

After the Kustomize 406 stage, the configurations pass through an encryption module 409. This module may encrypt sensitive information within the configuration files, enhancing the security of the deployment process. The encrypted configurations are then be applied to the workload cluster 410, which represents the target environment for the RDOE deployment. The diagram also shows two orchestration components operating in parallel with the main configuration flow. The services orchestrator 404, which may include a Crossplane 405 component, may be responsible for managing and deploying various services within the RDOE. The environment orchestrator 411, featuring a FluxCD 412 component, may handle continuous delivery and GitOps-style management of the environment. This deployment process 400 may provide a structured approach to configuring, securing, and deploying the RDOE, incorporating industry-standard tools and practices for configuration management, security, and orchestration. The process may allow for flexibility in deployment while maintaining consistency and security across different environments or client requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A number of implementations have been described. Nevertheless, it will be understood that various modifications may be made without departing from the spirit and scope of the disclosure. Accordingly, other implementations are within the scope of the following claims.

1. A system for deploying a model-based systems engineering (MBSE) environment, comprising:
a management cluster configured to deploy a workload cluster;
a rapid deployable orchestrated environment (RDOE) implemented within the workload cluster, the RDOE comprising:
a server-based application configured to store MBSE model data; and
a client development application configured to manipulate the MBSE model data;
wherein the RDOE is partitionable into separate areas for multiple client companies to utilize.

2. The system of claim 1, wherein the server-based application comprises a model repository configured to store MBSE model data.

3. The system of claim 2, wherein the model repository includes template components, reuse library components, and reference architecture components.

4. The system of claim 1, wherein the server-based application comprises a license manager configured to manage licenses for the client development application.

5. The system of claim 4, wherein the license manager includes guide components, client license components, and server license components.

6. The system of claim 1, wherein the server-based application comprises a source code repository configured to store deployment configuration files.

7. The system of claim 6, wherein the source code repository includes template components and guide components.

8. A method for deploying a model-based systems engineering (MBSE) environment, comprising:
deploying a workload cluster using a management cluster;
implementing a rapid deployable orchestrated environment (RDOE) within the workload cluster;
configuring a server-based application within the RDOE to store MBSE model data;
configuring a client development application within the RDOE to manipulate the MBSE model data; and
partitioning the RDOE into separate areas for multiple client companies to utilize.

9. The method of claim 8, wherein configuring the server-based application comprises implementing a model repository to store MBSE model data, the model repository including template components, reuse library components, and reference architecture components.

10. The method of claim 8, wherein configuring the server-based application comprises implementing a license manager to manage licenses for the client development application, the license manager including guide components, client license components, and server license components.

11. The method of claim 8, wherein configuring the server-based application comprises implementing a source code repository to store deployment configuration files, the source code repository including template components and guide components.

12. The method of claim 8, further comprising:
implementing multiple versions of the client development application and the server-based application within the RDOE; and
enabling migration of data between different versions of the client development application and the server-based application.

13. The method of claim 12, further comprising implementing automated data backup and disaster recovery processes for the RDOE.

14. The method of claim 13, further comprising:
implementing infrastructure-as-code (IaC) to orchestrate the RDOE; and
utilizing the IaC to enable drift correction and configuration management to maintain security of the RDOE.

15. A non-transitory computer-readable medium storing instructions that, when executed by a processor, cause the processor to perform operations for deploying a model-based systems engineering (MBSE) environment, the operations comprising:
deploying a workload cluster using a management cluster;
implementing a rapid deployable orchestrated environment (RDOE) within the workload cluster;
configuring a server-based application within the RDOE to store MBSE model data;
configuring a client development application within the RDOE to manipulate the MBSE model data; and
partitioning the RDOE into separate areas for multiple client companies to utilize.

16. The non-transitory computer-readable medium of claim 15, wherein configuring the server-based application comprises implementing a model repository to store MBSE model data, the model repository including template components, reuse library components, and reference architecture components.

17. The non-transitory computer-readable medium of claim 15, wherein configuring the server-based application comprises implementing a license manager to manage licenses for the client development application, the license manager including guide components, client license components, and server license components.

18. The non-transitory computer-readable medium of claim 15, wherein configuring the server-based application comprises implementing a source code repository to store deployment configuration files, the source code repository including template components and guide components.

19. The non-transitory computer-readable medium of claim 15, the operations further comprising:
implementing multiple versions of the client development application and the server-based application within the RDOE; and
enabling migration of data between different versions of the client development application and the server-based application.

20. The non-transitory computer-readable medium of claim 19, the operations further comprising:
implementing automated data backup and disaster recovery processes for the RDOE;
implementing infrastructure-as-code (IaC) to orchestrate the RDOE; and
utilizing the IaC to enable drift correction and configuration management to maintain security of the RDOE.
